(19) United States
(12) Patent Application Publication
(10) Pub. No.: US 2024/0211817 A1
(43) Pub. Date: Jun. 27, 2024

(54) PORTABLE DEVICE COMPRISING SENSOR AND IC CHIP

(71) Applicant: Unho CHOI, Toronto (CA)

(72) Inventor: Unho CHOI, Toronto (CA)

(21) Appl. No.: 18/346,224

(22) Filed: Jul. 1, 2023

Related U.S. Application Data
(63) Continuation of application No. 17/832,033, filed on Jun. 3, 2022, now abandoned.
Application No. 17/832,033 is a continuation of application No. 13/440,451, filed on Apr. 5, 2012, now abandoned.
Application No. 13/440,451 is a continuation of application No. PCT/KR2010/006702, filed on Sep. 30, 2010.

(30) Foreign Application Priority Data
Oct. 8, 2009 (KR) 10-2009-0095871
Dec. 8, 2009 (KR) 10-2009-0120987

(51) Int. Cl. G06Q 10/02

(52) U.S. Cl. CPC G06Q 10/02

(57) ABSTRACT

A portable device for biometric authentication comprises a sensor and an IC chip. It optionally comprises a one-time password generator. The sensor is configured to acquire a biometric pattern from a user. The IC chip is configured to: store first biometric information of a registered subscriber; store second biometric information that matches or is identical to the first biometric information; determine whether the biometric pattern is matched with the first biometric information and with the second biometric information; and transmit authentication information to a remote server or terminal when the biometric pattern is matched with both the first biometric information and the second biometric information.

### CROSS-REFERENCE TO RELATED APPLICATIONS

This application is a continuation of application Ser. No. 17/832,033 filed on Jun. 3, 2022, which is a continuation of application Ser. No. 13/440,451 filed on Apr. 5, 2012, which is a continuation of International Application No. PCT/KR2010/006702 filed on Sep. 30, 2010, which claims priority from Korean Application Nos. 10-2009-0120987 filed on Dec. 8, 2009 and 10-2009-0095871 filed on Oct. 8, 2009. The aforementioned applications are incorporated herein by reference in their entireties.

### TECHNICAL FIELD

The present invention relates to a method and a system for providing a public equipment rental service using a biometric authentication card, and more particularly to a method and a system for providing public equipment rental services using a biometric identity card, which provides a rental service involving a biometric authentication card that provides user authorization function using the renter's biometric characteristics.

### RELATED ART

The statements in this section merely provide background information related to the present disclosure and may not constitute prior art. Many people use rental services on public equipment such as bicycles, wheelchairs, laptops, carts, and rides in public places such as a park crowded with many people or in a supermarket. The management of the renter and the equipment for rental services, however, has not been effectively performed. The public rental equipment gets frequently lost due to failure of the return from the renter. Since there has been little automated management of the renters and the rental equipment, there is a tendency that the renters recklessly use or keep the rented equipment without a sense of responsibility, and therefore it may cause problems that the public equipment are quickly damaged or easily lost.

### SUMMARY

Therefore, a preferred embodiment of the present invention provides a method and a system for providing a public equipment rental service using a biometric authentication card, which provides a user authorization function through a biometric authentication, thereby reducing the equipment loss, and preventing the equipment damage by enhancing a sense of duty of the renter on the public equipment.

Another preferred embodiment of the present invention further provides a method and a system for providing a public equipment rental service using a biometric authentication card, in which it involves the biometric authentication card which provides the user authorization function through the biometric authorization for the rental service of the public equipment, and provides at least one card functions of the transportation card function and the credit card function as well.

An aspect of the present disclosure provides a system for providing a rental service system for public equipment using a biometric authentication card, the system comprising: a reservation processing unit for receiving an on-site reservation request or an Internet reservation request for a public equipment rental service through an on-site reservation unit or the internet, and performing an on-site reservation process or an internet reservation process; a user authorization section for receiving a user authorization request using a biometric authentication card of a user who has requested the on-site reservation request or the internet reservation request and performing a user authorization for the user; and a rental processing unit for processing a public equipment rental service for a reservation through the on-site reservation or the Internet reservation for the user.

Another aspect of the present invention provides a rental service system for public equipment using a biometric authentication card, the system comprising: a biometric authentication card for performing the user authorization by authenticating a biometric information; and a rental terminal for confirming a rental availability of public equipment by controlling a locking function of a rack keeping the public equipment upon a user authorization result.

An additional aspect of the present invention provides a rental service method for public equipment using a biometric authentication card, the method comprising: a user authorization step for performing a user authorization by authenticating a biometric information stored in the biometric authentication card; and a rack controlling step, at a rental terminal, for releasing the public equipment upon a user authorization result.

According to the present invention as described above, it has advantageous effects of reducing a public equipment loss, and of preventing a public equipment damage by enhancing a sense of responsibility of the users on the public equipment, by providing public equipment rental services using a biometric authentication card having the user authorization function using the biometric authentication.

Further, according to the preferred embodiment of the present invention, it has advantageous effects of using not only the rental services, but also a transportation card function, and a credit card function with one biometric authentication card without possessing different kinds of multiple cards by providing the biometric authentication card which provides the user authorization function through the biometric authorization for the rental service of the public equipment, and provides at least one of card functions of the transportation card function and the credit card function as well.

### BRIEF DESCRIPTION OF THE DRAWINGS

FIG. 1 is a block diagram showing a rental service system for a public equipment using a biometric authentication card according to a preferred embodiment of the present invention.

FIG. 2 is a diagram schematically showing a rental service system for a public equipment using a biometric authentication card according to a preferred embodiment of the present invention.

FIG. 3 is a block diagram showing a rental service system for a public equipment using a biometric authentication card according to a preferred embodiment of the present invention.

FIG. 4 is a block diagram showing a biometric authentication card according to a preferred embodiment of the present invention.

FIG. 5 is a flowchart illustrating a rental service method for a public equipment using a biometric authentication card according to a preferred embodiment of the present invention.

FIG. 6 is a diagram illustrating an exemplary rental service process of the rental service system for a public equipment using a biometric authentication card according to a preferred embodiment of the present invention.

FIG. 7 is a diagram illustrating an exemplary biometric authentication card according to a preferred embodiment of the present invention.

### DETAILED DESCRIPTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as “connected,” “coupled,” or “linked” to another component, they may mean the components are not only directly “connected,” “coupled,” or “linked” but also are indirectly “connected,” “coupled,” or “linked” via a third component.

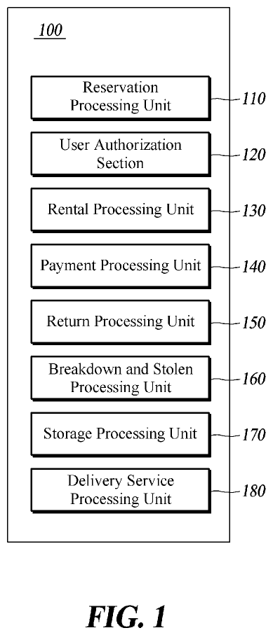

FIG. 1 is a block diagram showing a rental service system 100 for a public equipment using a biometric authentication card according to a preferred embodiment of the present invention.

Referring to FIG. 1, the rental service system 100 for the public equipment using the biometric authentication card according to the preferred embodiment of the present invention comprises a reservation processing unit 110 for receiving an on-site reservation request or an Internet reservation request for a public equipment rental service through an on-site reservation device or the Internet, and performing an on-site reservation process or the Internet reservation process; a user authorization section 120 for receiving a user authorization request through a biometric authentication card of a user who has requested the on-site reservation request or the Internet reservation request and for performing the user authorization; and a rental processing unit 130 for executing a rental process for the authorized user.

The user authorization section 120, upon receiving the Internet reservation request from the reservation processing unit 110, may perform the user authorization for the user by combining a biometric authorization result from the biometric authentication card with either a public key certificate or an one-time password (OTP). The public key certificate is sort of an electronic certificate with which trade partners trust each other in on-line trades. The certificate may be issued from an authorized certificate issuer, and it comprises a username who owns the certificate, a validity term, a public key for confirming digital signature of the user, and a digital signature value of the authorized certificate issuer that authenticates such content.

The biometric authentication card as mentioned above may be implemented as a kind of smart card or a kind of Universal Serial Bus (USB) security token having USB interface.

Referring to FIG. 1, the rental service system 100 for a public equipment using a biometric authentication card according to a preferred embodiment of the present invention further comprises a payment processing unit 140 for processing a rental fee payment for rented equipment upon receiving the user authorization result.

Referring to FIG. 1, the rental service system 100 using a biometric authentication card further comprises one or more of: a return processing unit 150 for receiving an on-site return request or a remote place return request for the public equipment through an on-site return device or the Internet, processing an on-site return process or a remote place return process, and updating a rental log for the renter; a damage/theft processing unit 160 for receiving a damage report or a theft report for a rented item through an on-site report device or the Internet, and executing a damage process or a theft process for generating and storing a damage information or a theft information for the rented item; a storage processing unit 170 for receiving a storage request for an item to be rented through the on-site report device or the Internet, and performing a storage process for generating and storing a storage information for the rented item; and a delivery service processing unit 180 for receiving a delivery request for the public equipment for rental or a personal item (for example, bicycle, baby carriage, etc.) through the on-site report device or the Internet, and requesting a delivery of the rental item or the personal item by generating and storing a delivery request information therefor.

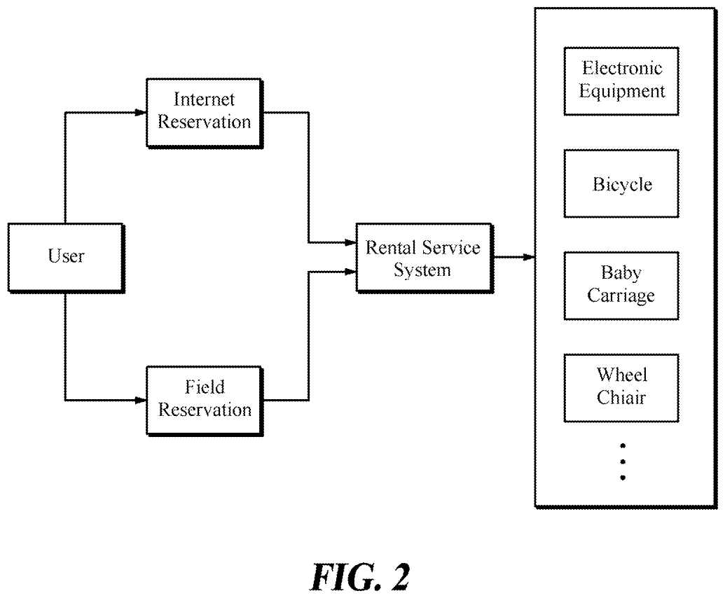

FIG. 2 is a diagram schematically showing a rental service system for public equipment using a biometric authentication card according to a preferred embodiment of the present invention. Referring to FIG. 2, a user (for example, VIP, the handicapped, the weak and the elderly, children or others) may make an on-site reservation of the rental items such as multipurpose PDAs, bicycles, baby carriages, wheelchairs or make an Internet reservation through the Internet from home or office, by using a device which implements the rental service system 100 and is located near, e.g., a rental office gate, a parking lot, etc. The fee payment related with the on-site reservation or the Internet reservation, upon the user authorization using the biometric authentication card, can be processed as pre-payment or post-payment.

The rental service system 100 illustrated in FIG. 1 may be installed nearby, e.g., parks, biking routes, exhibition sites, performance halls, tourist sites, and may be implemented as, e.g., a touch-screen type kiosk.

Meanwhile, when using the rental service system 100, it is possible for a user to store not only public rental items but also personal items such as bicycles, baby carriages, wheelchairs, electronic devices (for example, laptops, PDAs, etc.) in a certain user-designated place for a certain period of time, or to deliver such items from one place to another.

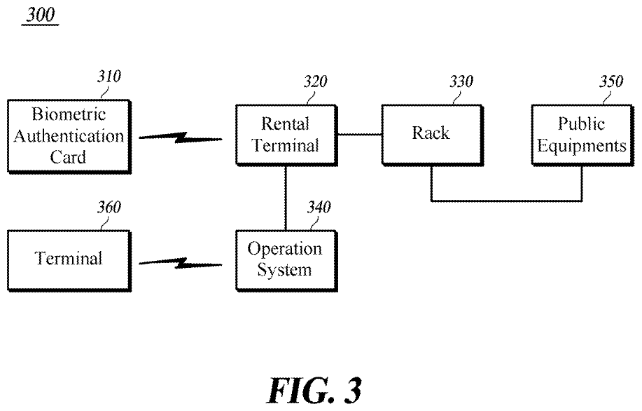

Referring to FIG. 3, the rental service system 100 comprises a biometric authentication card 310 for performing the user authorization by authenticating a biometric information; and a rental terminal 320 for controlling release of a lock etc. for rental equipment upon the user authorization result through a biometric authentication card 310.

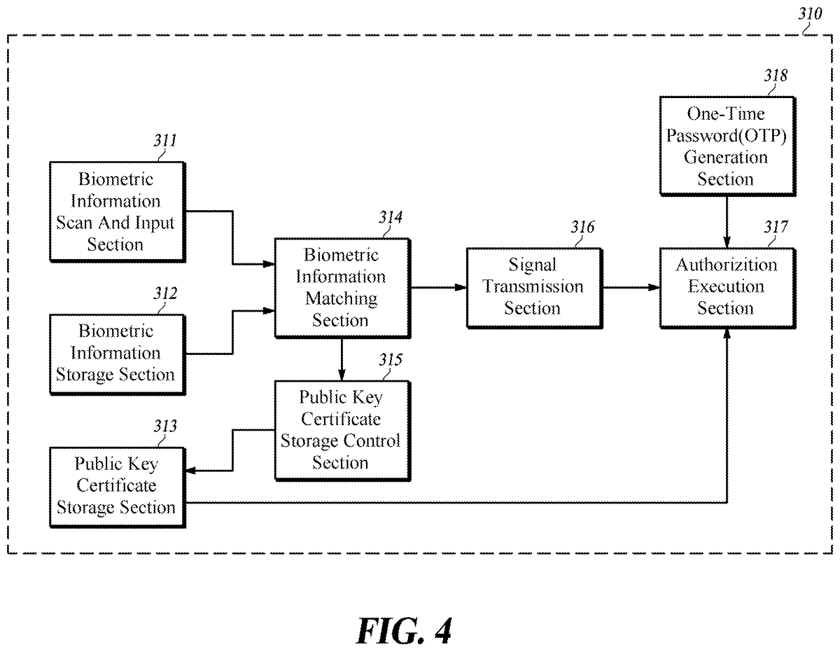

As illustrated in FIG. 4, the biometric authentication card 310 may comprise a biometric information scan and input section 311, a biometric information storage section 312, a public key certificate storage section 313, a biometric information matching section 314, a public key certificate storage control section 315, a signal transmission section 316, an authorization execution section 317, and a one-time password (OTP) generation section 128.

A rental service provider stores biometric information of a subscribed user and issues a biometric authentication card 310 matching the stored biometric information. The biometric authentication card issuance server (not illustrated) of the rental service provider issues, when a client subscribes as a member and registers his or her biometric information to be used with the rental service, a biometric authentication card 310 upon storing the biometric information which matches or is identical to the registered biometric information in the biometric authentication card 310. The biometric information comprises at least one of: fingerprint pattern recognition information, vascular pattern recognition information, voice pattern recognition information, iris pattern recognition information, and palm pattern recognition information of the subscribed user.

The biometric authentication card issuance server may store a public key certificate of a subscriber in the public key certificate storage section 313 and may issue the public key certificate. The biometric authentication card issuance server can not only issue the public key certificate of the subscriber and store it in the public key certificate storage section 313, but also store the public key certificate of the subscriber which it received from a certificate authority and store it in the public key certificate storage section 313. The biometric authentication card issuance server may encode the biometric information of the subscriber and insert the encoded biometric information of the subscriber into the public key certificate which is stored in the public key certificate storage section.

The biometric information scan and input section 311 receives the user biometric information of the biometric authentication card 310. The biometric information scan and input section 311 may be implemented as at least one of a fingerprint recognition sensor, an iris recognition sensor, a voice recognition sensor, a vascular recognition sensor, and a palm recognition sensor.

The biometric information storage section 312 stores the biometric information of the subscriber registered in the biometric authentication card issuance server. The biometric information storage section 312 stores the biometric information corresponding to the kind of a sensor of the biometric information scan and input section 311. That is, when the biometric information scan and input section 311 is implemented as a fingerprint scan sensor, the biometric information storage section 312 stores the fingerprint pattern recognition information of the registered subscriber as the biometric information, while it stores the iris pattern recognition information of the registered subscriber as the biometric information when the biometric information scan and input section 311 is implemented as the iris scan sensor.

The biometric information storage section 312 can store a plurality of biometric information of the registered subscriber. For example, when storing the fingerprint pattern recognition information of the registered subscriber as the biometric information, the fingerprint pattern recognition information of each finger may be stored, and the iris pattern recognition information of both eyes may be stored when storing the iris pattern recognition information of the registered subscriber as the biometric information.

The public key certificate storage section 313 stores the public key certificate which is issued by the public key certificate issuance server 110. In this case, only an organization issuing the biometric authentication card 310 may be allowed to store the public key certificate in the public key certificate storage section 313. On the other hand, the user accesses the issuance server of the biometric identification card 310 through a communication network in order to store the public key certificate in the public key certificate storage section 313, or make a copy of the public key certificate from a personal computer and store the public key certificate in the public key certificate storage section 313.

The biometric information matching section 314 checks whether the biometric information which is inputted by the biometric information scan and input section 311, matches the biometric information stored in the biometric information storage section 312. Specifically, it is checked whether the biometric information of a smart card user matches the biometric information of the user registered in the public key certificate issuance server.

When the public key certificate storage control section 315 stores a public key certificate in the public key certificate storage section 313, it may be determined whether the information matching the biometric information of the user is included in the public key certificate, only if the biometric information of the user inputted by the biometric information scan and input section 311 matches the biometric information stored in the biometric information storage section 312. Similarly, the public key certificate storage control section 315 may be implemented to store the received public key certificate in the public key certificate storage section 313 only when it is determined that the received public key certificate includes the information matching the biometric information of the user. Therefore, firstly, the public key certificate storage control section 315 may be designed to allow only the authorized user of the biometric authentication card 310 to store the public key certificate in the public key certificate storage section 313, and secondly, the public key certificate stored in the public key certificate storage section 313 may be implemented to be limited only for the public key certificate including the information matching the biometric information for the authorized user. As an alternative, since such conditions and limitations are to tighten up the authorization procedure by the biometric authentication card 310, it can be implemented to store the corresponding public key certificate without the process for matching the biometric information.

The signal transmission section 316 transmits a tunneling start signal to establish communication tunnel to a target terminal when it is determined that the biometric information inputted by the biometric information scan and input section 311 matches the biometric information stored in the biometric information storage section 312. Herein, the target terminal is a rental terminal 320 which directly connects itself to the biometric authentication card 310 through a wired or a wireless network, or is a certain service providing server like an operation system 340 for operating the rental service of the communication terminal which is connected through the network or the public equipment. If the target terminal is the certain service providing server or terminal connectable through a network, the location of the target terminal on the network can be set as a Uniform Resource Locator (URL), and the communication tunnel can be set up by establishing a Virtual Private Network (VPN) with the determined URL.

When a plurality of biometric information on the registered subscriber are stored in the biometric information storage section 312, the signal transmission section 316 may be implemented to transmit the tunneling start signal to a different target terminal depending on the biometric information matching the biometric information inputted through the biometric information scan and input section 311. For example, in case the fingerprint pattern recognition information for a plurality of the fingers of the subscriber registered in the biometric information storage section 312 are stored as the biometric information, then the communication tunnel may be established to a safety management server such as a police server if any specific one of any fingerprint pattern recognition information is set to correspond to the safety management server, and subsequently an emergency signal is generated and transmitted to the server to file a report using the specific finger in such an emergency state that the user is forced to execute the authorization process using the biometric authentication card 310 under the threat of someone else.

When the biometric information inputted through the biometric information scan and input section 311 matches the biometric information stored in the biometric information storage section 312, the authorization execution section 317 executes the user authorization and transmits the result to the rental terminal 320. Also, the authorization execution section 317, when the communication tunnel is established to the target terminal by the signal transmission section 316, transmits the authorization information based on the public key certificate stored in the public key certificate storage section 313 to the corresponding target terminal.

The OTP generation section 218 generates the OTP in a way set by the issuance organization of the biometric authentication card 310. The OTP generated by the OTP generation section 318 is displayed so that the user of the biometric identification card 310 can view it, and the authorization execution section 315 may be configured to transmit the authorization information to the target terminal upon completing the authorization process on the user of the biometric authentication card 310 by using the OTP inputted by the user. As an alternative implementation, the OTP generated by the OTP generation section 318 is not made visible by the user of the biometric authentication card 310, and the authorization execution section 317 combines the OTP generated by the OTP generation section 318 with the authorization information and transmits the combined one to the target terminal, so as to ensure that the corresponding biometric authentication card 310 has been issued by a duly authorized issuance organization.

Such a biometric authentication card 310 is not limited to a card type one, but can be implemented as a dongle, a USB token, etc.

The rental terminal 320 as mentioned above, in the state of the public equipments350 being hold on the rack 330 by a locking device, receives an execution result information (user authorization success) which indicates the success of the user authorization using the biometric authentication card 310, and controls the locking device to release the public equipment 350 from the rack 330.

The biometric authentication card 310 as mentioned above may be designed to store the biometric information of a card possessor in a storage media (for example, integrated circuit chip, etc.), compare the biometric information recognized by the biometric information recognition device with the stored biometric information, execute the user authorization according to the comparison result, and transmit the execution result of the user authorization (user authorization success or failure) to the rental terminal 320.

The biometric authentication card 310 as mentioned above may recognize one or more of: fingerprint pattern recognition information, vascular pattern recognition information, voice pattern recognition information, and iris pattern recognition information as the biometric information through the corresponding biometric information recognition device.

The rental terminal 320 as mentioned above, may comprise a rental fee payment device for processing a rental fee payment for the rented equipment 350. The rental fee payment device reads the card information from the biometric authentication card 310. This rental fee payment method is a pre-payment type.

Meanwhile, the rental terminal 320 may comprise a rental fee payment device for reading the card information from the biometric authentication card 310, as of pick-up or return of the rental equipment 350, calculating the rental time of the rental equipment 350 based on the pick-up time and the return time of the rented equipment 350, and processing the rental fee payment of the rental equipment 350 based on the calculated rental time. Such rental fee payment method is a way of paying different rental fees based upon the calculated rental time (from the pick-up time to the return time) after the return of the rented equipment 350.

Meanwhile, as illustrated in FIG. 3, the rental service system 300 for the rented equipment using the biometric authentication card according to another preferred embodiment of the present invention may further comprise an operation system 340. The operation system 340 stores and manages the rental service information including at least one of a rental information, a return information, and a rental fee information for the rented equipment by inter-working with the rental terminal 320, and transmits a guide message including the rental service information to a user terminal of the user who has rented the public equipment 350.

The user authorization result information included in the rental service information, for instance, comprises the information on the result (user authorization success or failure) of the user authorization by checking the biometric information through the biometric authentication card 310. The rental information comprises at least one of pick-up time, rental availability, information on a rental item, and pick-up place. The return information comprises at least one of return time, return status, information on a rental item, and return place, etc. The rental fee information comprises at least one of total rental time, total rental fee, payment status, and payment-related information.

The operation system 340 transmits a notice message informing rental service information which includes user authorization result information, rental information, return information, and rental fee information, etc. to the terminal 360 of the user who is the owner of the biometric authentication card 310. The card owner of the biometric authentication card 310 can check the information on the rental service used by the owner and may further check whether his or her biometric authentication card 310 is used by an unallowed user after the card owner has lost his or her biometric authentication card 310.

The biometric authentication card 310 may provide further functions such as a transportation card function for subway and bus, or a credit card function for the payment at the off-line store such as hospitals or restaurants or an online shopping mall, on top of the user authorization and rental fee payment.

A terminal 360 in FIG. 3 can be a computer, an IPTV set-top box, a CD/ATM, a kiosk or a mobile phone which can install or can be installed beforehand with the user authorization section 120. Here, the biometric authentication card 310 is illustrated as it is composed separately from the terminal 360, but it is not limited to that, and the biometric authentication card 310 can combine with the terminal 360 and be implemented as one user authorization device.

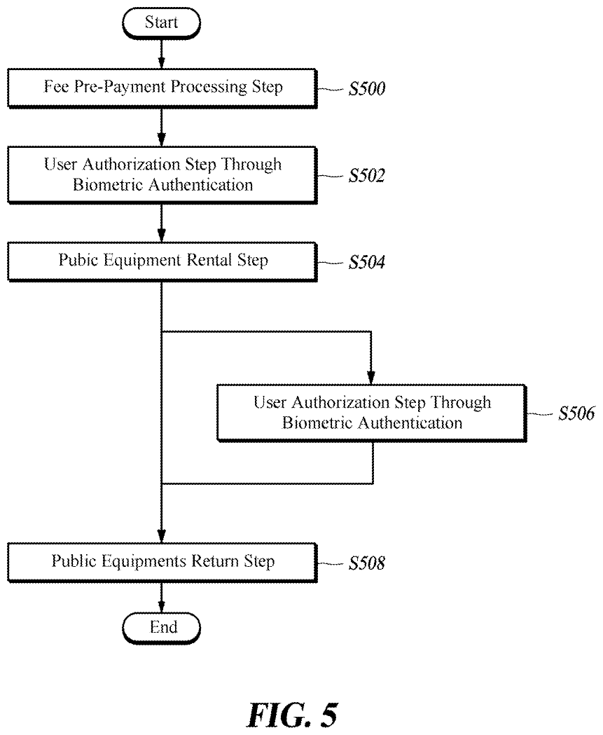

In the rental service system 300 using the biometric authentication card according to another preferred embodiment of the present invention, the public equipment that are rented to the user carrying the biometric authentication card 310 comprise at least one of bicycles, wheelchairs, baby carriages, laptops, carts, and rides. The rental service system 300 using the biometric authentication is described in FIG. 5.

The FIG. 5 is a flowchart illustrating a rental service method for public equipment using a biometric authentication card according to a preferred embodiment of the present invention. This is a method provided by the rental service system 300 for public equipment using the biometric authentication card according to a preferred embodiment of the present invention.

Referring to FIG. 5, the rental service method for public equipment using the biometric authentication card according to a preferred embodiment of the present invention comprises a user authorization step S502 of performing a user authorization by authenticating a biometric information in the biometric authentication card 310; and a public equipment rental step S504 of managing the availability of the rental of the public equipment by controlling lock of a rack 330 according to the user authorization execution result by using the biometric authentication card 310.

In the public equipment rental step S504, when the rental terminal 320, in the state of the public equipment 350 being held on the rack 330 by using a locking device, receives the execution result information and if it is a success, controls to release the public equipment 350 from the rack 330.

Referring to FIG. 5, before the user authorization step S502 through the biometric authentication, the rental terminal 320 may further comprise a fee pre-payment processing step S500 processing the payment of the public equipment rental fee upon the rental of the public equipment by reading a card information from the biometric authentication card. The rental fee payment method through the fee pre-payment processing step S500 is a way of paying the certain rental fee in advance before renting the public equipment.

The flowchart illustrated in FIG. 5, is a flowchart illustrated as assuming the pre-payment of a rental fee corresponding to a certain rental time of a public equipment 350 before the actual rental of the public equipment 350 (for example, before the user authorization step S502 through the biometric authentication). Assuming the case of fee post-payment upon the rental time calculated based on the pick-up time and return time after the rented public equipment 350 is returned, instead of the pre-payment processing step S500. The rented equipment return step S508 of returning the public equipment 350 comprises a fee post-payment processing step of calculating the rental duration of the rented equipment by reading the card information from the biometric authentication card 310, and processing the payment of the rental fee of the rented equipment 350 based on the calculated time. This fee payment method is a way of paying the rental fee differently according to the rental time (from rental time to return time) calculated after the public equipment 350 is returned.

Meanwhile, the rental service method for the public equipment using the biometric authentication card according to a preferred embodiment of the present invention further comprises a notice message transmission step of transmitting the notice message including rental fee information which is paid after the fee pre-payment processing step S500 to a terminal 360 of the user, or transmitting the notice message including user authorization result information after user authorization step S502 through the biometric authentication to a terminal 360 of the user, or transmitting the notice message including the rental information after the public equipment rental step S504 to a terminal 360 of the user, or transmitting the notice message including return information after the public equipment return step S508 to a terminal 360 of the user, or transmitting the notice message including the state of return and (in fee deferred payment) rental fee information after the public equipment return step S306. It further comprises return/theft/storage/delivery processing steps S506 such as return process, theft-handling process, storage process, delivery process, on top of the return notice message transmission, among the processes until the return of the rented item after the pick-up of the rented item.

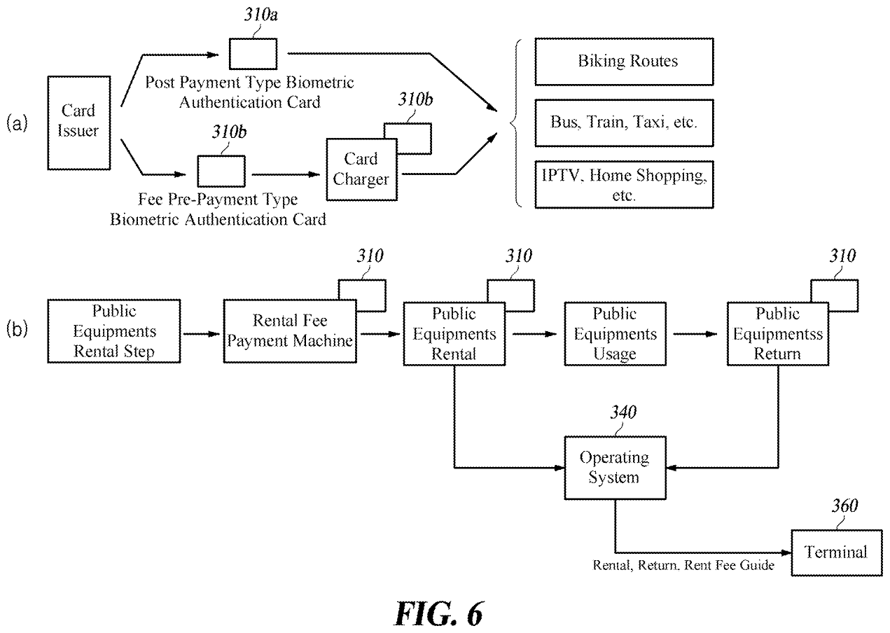

In the rental service method for the public equipment using the biometric authentication card according to a preferred embodiment of the present invention, the public rental equipment that are rented to the user who possesses the biometric authentication card 310 comprise, as an example, at least one of bicycles, wheelchairs, laptops, carts, and rides. The service on the rental service system 300 using the biometric authentication card 310 is described with reference to FIG. 6.

FIG. 6(a) is a diagram illustrating an example of use after the issuance of the biometric authentication card 310. Referring to FIG. 6(a), the user can rent a bicycle from a spot at a bike path or use public transportation means such as bus, subway, taxi, or use as a user identification and payment means when using IPTV or home shopping, etc. after charging the card with a certain amount of money using a card charging machine, upon being issued a fee pre-payment type biometric authentication card 310b or a post-payment type biometric authentication card 310b.

FIG. 6(b) is a diagram showing an exemplary procedure using the rental service using the biometric authentication card 310. Referring to FIG. 6(b), the user goes to the public equipment rental spot in which the user rents the desired public equipment, in case of paying the fee in advance, and pre-pays the rental fee partly by completing the user authorization procedure using the biometric authentication card 310. The user may use the public equipment by renting the desired public equipment after the completion of the user authorization using the biometric authentication card 310. The user uses the rented public equipment until the return time. The user returns the rented item at the prescribed return time or at the time when the user wants to stop using it through the user authorization with the biometric authentication card 310. Meanwhile, when picking-up and returning the rented equipment, the rental service system 300 notifies the information on such as rental, return, and fee payment to the operation system 340, and the operation system 340 uses an SMS message to notify this information to the terminal 360 such as a mobile phone of the renter.

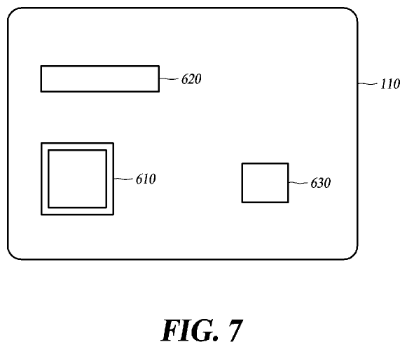

The biometric authentication card 310 as mentioned above and as illustrated in FIG. 7 comprises: a biometric authentication device 610 for recognizing the biometric information such as a fingerprint pattern recognition information; a one-time password (OTP) display section 620; and an IC chip 630. It may also store the public key infrastructure (PKI) information.

The biometric authentication card 310 is configured to store registered biometric information and various kinds of information in the biometric authentication device 610, IC chip 630 or a storage area within the card in order to compare it with the PKI and the authenticated biometric information. In addition, the biometric authentication card 310 can be implemented as a kind of a smart card. The OTP and/or the PKI as mentioned above can be used in at least one process of rental sign-up, fee payment, return, storage, delivery of the public rental equipment or personal equipment through the Internet reservation.

According to the present disclosure as described above, it has advantageous effects of reducing the loss of the rental equipment loss and preventing the damage of the public equipment by enhancing a sense of duty on the public equipment because of the user authorization process.

Furthermore, according to the preferred embodiment of the present invention, it has advantageous effects of expanding the usability of the card beyond the rental service, to such as the transportation card function and the credit card function with only one biometric authentication card obviating the need to possess different kinds of multiple cards.

As above, even though it is explained that all components comprising the preferred embodiment of the present invention are combined or operated after combined, the present invention is not always limited to such preferred embodiment. That is, at least one of those all components can be combined selectively and can be operated. Also, all components can be implemented respectively as an independent hardware, but also it can be implemented as the computer program having program module which performs some or all functions that are combined in one or a plurality of hardware, as some or all of components are combined selectively. The codes and code segments comprising the computer program can be easily inferred by the person in charge of technical field of the present invention. Such computer program is stored in the computer readable media, and is read and executed by the computer, and can embody the preferred embodiment of the present invention. A magnetic record media, an optical record media, and a carrier wave media are comprised as the computer program storage media.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like “include,” “comprise,” and “have” should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

What is claimed is:

1. A portable device comprising:
a sensor configured to acquire a biometric pattern from a user who attempts to access the portable device; and
an IC chip configured to:
store first biometric information of a registered subscriber who has been registered to be authorized to use the portable device;
store second biometric information that matches or is identical to the first biometric information;
determine whether the biometric pattern is matched with the first biometric information and with the second biometric information; and
transmit authentication information to a remote server or terminal when the biometric pattern is matched with both the first biometric information and the second biometric information, and not transmit authentication information when the biometric pattern is not matched with the first biometric information or when the biometric pattern is not matched with the second biometric information.

2. The portable device according to claim 1, further comprising a one-time password (OTP) generator.

3. The portable device according to claim 1, wherein the sensor is a fingerprint recognition sensor, a vascular recognition sensor, a palm recognition sensor, a voice recognition sensor, an iris recognition sensor, or a combination thereof.

4. The portable device according to claim 1, wherein the remote service or terminal is a server or terminal for managing rental service of a public equipment.

5. The portable device according to claim 1, wherein the portable device is implemented as a smart card.

6. The portable device according to claim 1, wherein the portable device is implemented as a universal serial bus (USB) token or a dongle.

7. The portable device according to claim 1, wherein the portable device is implemented as a mobile phone.

8. The portable device according to claim 1, wherein the second biometric information is contained in a public key certificate.

9. The portable device according to claim 8, wherein the public key certificate is contained in the IC chip.
